(19) United States
(12) Patent Application Publication
(10) Pub. No.: US 2009/0012858 A1
(43) Pub. Date: Jan. 8, 2009

(54) PRICE PROTECTION SYSTEM AND METHOD

(76) Inventors: David Marc Cohen, Mountain View, CA (US); James Wallace, New York, NY (US)

Correspondence Address: THE HECKER LAW GROUP, Suite 2300, 1925 Century Park East, Los Angeles, CA, 90067, US

(21) Appl. No.: 12/043,893

(22) Filed: Mar. 6, 2008

Related U.S. Application Data
(60) Provisional application No. 60/905,105, filed on Mar. 6, 2007.

(51) Int. Cl. G06Q 30/00

(52) U.S. Cl. 705/14

(57) ABSTRACT

Disclosed herein is a system and method for price protection associated with one or more items purchased. A registered item, which comprises an item purchased by a buyer from a seller, is monitored electronically to obtain information associated with the item, including an item's current purchase price. If it is determined from electronically monitoring the status of the item that the buyer is eligible for a refund under a price protection policy covering the item purchased, the buyer is notified.

### CROSS REFERENCE TO RELATED APPLICATION

This application claims the benefit of US. Provisional Patent Application No. 60/905,105, filed Mar. 6, 2007 and entitled “PRICE PROTECTR, NOTIFICATION SYSTEM”, the contents of which are incorporated herein by reference.

### FIELD OF THE INVENTION

This invention relates to consumer price protection, and more particularly to electronic recognition of a buyer's eligibility for a refund on at least one item, e.g., a product and/or service, covered by a price protection policy, e.g., a price protection policy of a seller of the item, and communication of a notification of such eligibility to the buyer.

### BACKGROUND

Many sellers offer a “price protection policy.” A price protection policy includes a policy whereby a seller or other commercial entity or individual (hereinafter “seller”) establishes a period of time beginning from the time of purchase and usually ending at some time thereafter, and the seller offers to refund the difference between a buyer's purchase price and a lower price set, e.g., by the seller, during the effective period (i.e. a price drop).

### SUMMARY OF THE DISCLOSURE

While many purchases are covered under a price protection policy, lack of knowledge on the part of a buyer results in the buyer being unable to take advantage of such a policy. The buyer may not be aware that the buyer is eligible for a refund under such a policy. For example, the buyer may not be aware that a price protection policy exists and/or that the buyer may not be aware of circumstances, e.g., the price of the item was reduced after the buyer purchased the item, that make the buyer eligible for a refund, for example. The present disclosure seeks to address failings in the art and provides a price protection system and method.

In accordance with one or more embodiments, a “Price Protection Notification System” (or PPNS) comprises a system, e.g., an extensible system, for use by consumers/individuals who purchase goods or services (hereinafter “buyers”), retailers and other commerce-related entities. The PPNS allows buyers to submit purchased items that are to be monitored by the PPNS. A buyer initiates the service provided by the PPNS by visiting a user interface (UI) provided by the PPNS and entering information associated with a purchase transaction involving a given item. Such information can include, without limitation, a URL that provides a link to a seller's web site for the item. Alternatively, the information associated with the item purchased can be provided via any electronic submission. For example, the information associated with the item purchased can be received via a data feed service, by which the information can be received by the PPNS. The information can be pushed to the PPNS, e.g., the PPNS can register to receive the information, or the PPNS can request the information, e.g., using an application programming interface (API) or other interface available to the PPNS for requesting the information.

In accordance with one or more embodiments, the “buyer” involved in a purchase transaction with another party becomes a “user” of the PPNS. In accordance with one or more such embodiments, during an item registration, the PPNS fetches information for use in determining the buyer's eligibility for a refund under a price protection policy offered by the seller or other party in connection with the item purchased by the buyer using a universal resource locator (URL,). By way of a non-limiting example, the PPNS can fetch a web page corresponding to a URL, link provided to the PPNS, parse the web page to retrieve the information related to the item and/or the price protection policy, e.g., the item's current price, name, and protection period etc. Item details fetched during item registration are communicated to the user, e.g., displayed in the UI of the PPNS, as part of item registration. The user can verify the information provided by the PPNS. The user provides confirmation that the information is correct and provides an electronic mail (email address) that the user desires the PPNS to use to communicate with the user, e.g., to notify the user of a change in status associated with the user's eligibility for a refund. Alternative mechanisms for contacting the user can be used, including without limitation, short message service (SMS) text message, instant message, or other form of electronic communication. An electronic notification comprises a mechanism, which can be any one or more of the mechanisms mentioned herein, and/or one or more mechanisms that is now known or later developed, to communicate electronically with a user.

In accordance with one or more embodiments, the PPNS automatically monitors the status of the item to determine whether or not the user is eligible for a refund under a price protection policy that covers the item purchased by the user. By way of a non-limiting example, the PPNS monitors a current price of the item in order to identify a change in price, e.g., by scanning the web page associated with the link provided by the user at regular intervals and/or requesting or receiving such information from a source. If the PPNS identifies a price drop, the PPNS can notify the user of the price drop, and/or the user's eligibility for a refund, via an electronic notification. In accordance with one or more embodiments, the electronic notification includes specific information about the item under protection and, depending on the output functionality desired by the administrator of the PPNS, will describe the steps the user is to use to collect the refund. The UI of the PPNS can further provide an account management capability to allow a user to modify and view statistics on each of the items they have submitted for protection.

By virtue of this arrangement, for example, the user is automatically notified of a change in an item's purchase price, and/or the user's eligibility for a refund under a price protection policy that covers the purchased item. The user's ability to take advantage of a price protection policy is therefore facilitated.

### DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 provides a general overview of components of a price protection notification system in accordance with one or more embodiments of the present disclosure.

FIG. 2 provides an item lookup catalog process flow for use in accordance with one or more embodiments of the present disclosure.

FIG. 3 provides a notification engine process flow for use in accordance with one or more embodiments of the present disclosure.

FIG. 4 provides an example of a user interface provided by a web-faced front end component in accordance with one or more embodiments of the present disclosure.

FIG. 5 provides an example of a general-purpose computer environment for use in accordance with one or more embodiments of the present disclosure.

### DETAILED DESCRIPTION

In general, the present disclosure includes a price protection and notification system, method and architecture. In the following description numerous specific details are set forth in order to provide a more thorough understanding of the present invention.

It will be apparent, however, to one skilled in the art, that the present invention may be practiced without these specific details. In other instances, well-known features have not been described in detail so as not to obscure the invention.

Certain embodiments of the present disclosure will now be discussed with reference to the aforementioned figures, wherein like reference numerals refer to like components.

Generally and in accordance with one or more embodiments, a “Price Protection Notification System” (or PPNS) comprises a system for use by consumers, e.g., buyers, retailers and other commerce-related entities, third parties and/or individuals involved in some manner in a purchase transaction involving goods or services. Other entities that may be involved include without limitation credit card companies, financial services, marketing agencies, a seller's competitor etc. The PPNS allows buyers to submit information about a purchased item, e.g., recently-purchased items, to the PPNS 100.

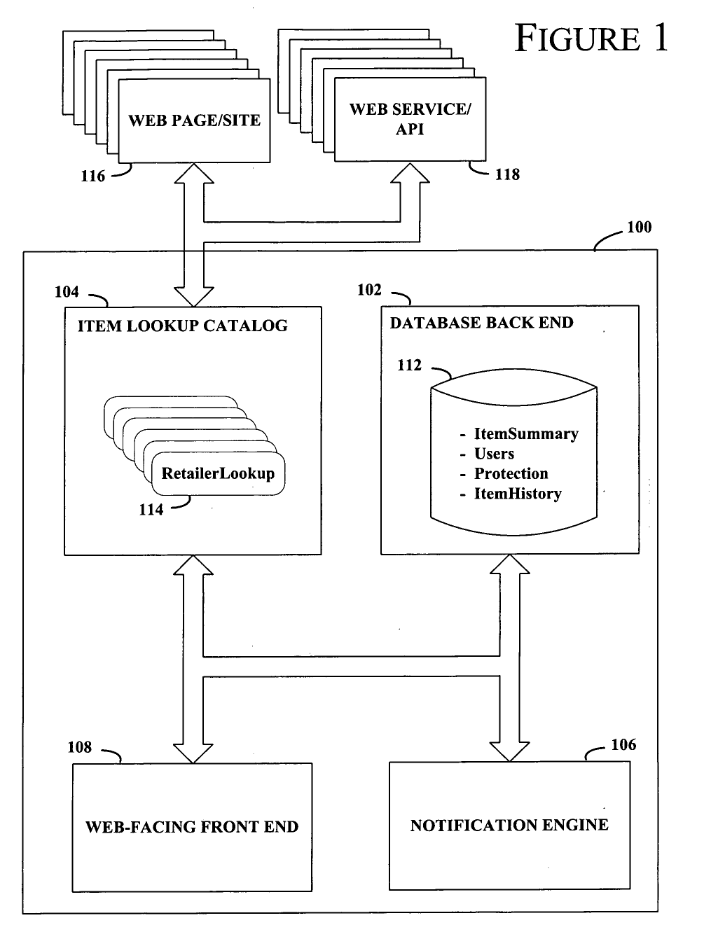

In accordance with one or more embodiments, the PPNS 100 comprises four components: a database back end 102, an item lookup catalog 104, a notification engine 106, and a web-facing front end 108, as shown in FIG. 1. The components can be implemented in software, hardware or some combination thereof.

A buyer initiates the service provided by the PPNS 100 by visiting a user interface (UI), e.g., one or more web pages of a web site provided by the web-faced front end 108 of the PPNS 100. Using the UI, the user enters information associated with a purchase transaction involving a given item. Such information can include, without limitation, a URL, that provides a link associated with the item, which is to be used by the PPNS 100 to retrieve information about the item. By way of a non-limiting example, the URL link can identify the URL associated with a web page that contains information, e.g., the purchase price, about an item that is to be monitored by the PPNS. For example, the URL link can identify a web page that displays the item and information, e.g., pricing, product identification etc. information. Alternatively, the information associated with the item that is to be monitored by the PPNS 100 can be provided via any type of submission. For example, the information can be fed, or pushed, via a data feed service to the PPNS 100 and/or the PPNS 100 can access an interface, such as an application programming interface (API) to retrieve the information from a source, collectively referred to herein as web service/API 118. It is contemplated that the PPNS 100 can obtain information from any source, including the seller that sold an item to the buyer. The source of the information used by the PPNS 100 can be an entity that is not involved in the purchase transaction. Other non-limiting examples of sources from which information can be obtained by the PPNS 100 include without limitation the buyer, a competitor of the seller, a credit card entity, financial services entity, marketing entity, etc.

In accordance with one or more embodiments, the PPNS 100 user includes, without limitation, a “buyer” involved in a purchase transaction of an item with another party, e.g., the “seller” of the item. The PPNS 100 fetches information for use in determining the buyer's eligibility for a refund under a price protection policy offered by the seller or other party in connection with the item purchased by the buyer. The PPNS 100 can fetch a web page corresponding to the URL link provided to the PPNS 100, for example.

In accordance with one or more embodiments, the PPNS 100 parses the web page to retrieve the item's current price, name, and price protection period from the web page contents using specific rules, e.g., rules specific to the seller and/or web page that is being parsed. By way of a non-limiting example, a RetailerLookup 114 component can use the rules specific to the web page to parse the web page to retrieve the desired information, for example. The PPNS 100 fetches the web page during the user's registration of the item with the PPNS 100. Item details fetched from the web page by the RetailerLookup 114 component's parsing of the web page, or via a web service/API 118, are communicated to the user as part of item registration.

The user verifies the information provided by the PPNS 100 during item registration. Information that is provided to the user for verification as part of item registration can include, without limitation, a price and date of the user's purchase. The user confirms the information and submits an electronic mail (email address) that the user desires the PPNS 100 to use to communicate with the user, e.g., to notify the user of a change in status associated with the user's eligibility for a refund. Alternative mechanisms for contacting the user can be used, including without limitation, SMS text message, instant message, or other form of electronic communication. A notification that uses a mechanism, which can be any one or more of the mechanisms mentioned herein, and/or one or more mechanisms that is now known or later developed, to communicate electronically with a user, is herein referred to as an “electronic notification”.

The PPNS 100 automatically monitors the item e.g., by scanning the web page identified using the link provided by the user at regular intervals and/or examining information received via another source, for a change in the item's information that is being monitored, e.g., for a change in one or more piece of information associated with the item, such as the item's price.

By way of a non-limiting example, the PPNS 100 monitors the status of the item at least once every twelve hours. In a case that the PPNS 100 obtains information by fetching and parsing one or more web pages associated with the item, e.g., a web page referenced by the URL link submitted during the item's registration, the PPNS 100 fetches the one or more web pages at least once every twelve hour period and parses the web page(s) to retrieve the item information. If the PPNS 100 identifies a price drop, the PPNS 100 can communicate with the user via an electronic notification. In accordance with one or more embodiments, the electronic notification includes specific information about the item under protection and, depending on the output functionality/configuration desired, e.g., such as by the administrator of the PPNS 100, can describe the steps the user would take to collect the refund. The PPNS 100 can further provide account management capability to allow a user to modify and view statistics on each of the items they have submitted for protection.

The database back end 102 provides a data management component for PPNS 100. It comprises a database 112 that includes an ItemSummary table, a Users table, a Protection table, and an ItemHistory table. The ItemSummary table contains a distinct set of information for each item added to the PPNS 100 by a user, including an item identifier (ID), an item URL and a name. The Users table includes information for each user in the PPNS 100, including such user information as a user ID, the user's email address (in a case that a notification is to be made via electronic mail), a SHA-1 hash of the user's password, the account creation time, and the last login time. As an alternative, or in addition to, a user email address, the Users table can include other contact information for the user, e.g., short message service (SMS) and/or instant message addressing information.

The Protection table includes item instances for each time the item has been added to the PPNS 100 by a user. For each item instance, the Protection table includes a protection ID, and item ID, which can be used as a foreign key into the ItemSummary table, a user ID, which can be used as a foreign key into the Users table, the date the item was purchased, the date the seller's price protection policy lapses, the original purchase price, the lowest price found for that item during the protection period, and a flag highlighting those items for which the price protection period has not lapsed.

The ItemHistory table stores history information that is collected each time the item was polled by the PPNS 100 including the item ID, which provides a foreign key into the ItemSummary table, the poll date, and the price at that time (e.g., the polling time).

In accordance with one or more embodiments, the item lookup catalog 104 comprises a modular subsystem that facilitates the addition of new sellers to the system. The item lookup catalog 104 is designed to retrieve and parse item information. By way of a non-limiting example, the item lookup catalog 104, retrieves and parses item information from any number of websites, such as retailer websites. While the terms retailer and seller are used herein, embodiments of the present disclosure are in no way limited to retailers and sellers per se. As is discussed herein, the PPNS 100 can be used to monitor an item using information obtained from any source using any type of mechanism to obtain such information. While a buyer and seller are typically involved in a purchase transaction, and information can be obtained from these entities, the PPNS 100 can obtain information from other sources, as discussed herein, to monitor an item. The term “monitored website” as it is used herein describes websites from which information is retrieved and parsed by the PPNS 100. A monitored page refers to a web page that is retrieved and parsed by the PPNS 100.

In addition and while embodiments of the present disclosure are discussed with reference to a seller and/or retailer that has an Internet presence, e.g., a web site through which a user can access/purchase an item, embodiments of the present disclosure are not limited to such. For example, it is possible to monitor an item that is purchased via a brick-and-mortar establishment, e.g., a neighborhood store. The buyer can become a user of the PPNS 100 by registering the item purchased at the brick-and-mortar establishment with the PPNS 100. It is likely that the brick-and-mortar establishment also has some type of Internet presence, which may be used as a source of information. Alternatively, it is possible to obtain item information from the seller or other entity, e.g., via a data store that can be queried by the PPNS 100, or other service that can accessed by the PPNS 100, and/or from information published electronically by the seller or other entity, e.g., electronic advertisement or message. As part of a process by which the buyer registers the item purchased with the PPNS 100, the PPNS can identify, e.g., from information provided by the buyer or otherwise, one or more sources from which the PPNS 100 can obtain information about the item purchased in order to monitor the item's pricing status under a purchase protection policy that covers the item.

The item lookup catalog 104 comprises one or more subcomponents referred to herein as the RetailerLookup component 114. A RetailerLookup component 114 is used to retrieve information about a given monitored web site and is capable of retrieving and parsing item names, prices, and protection periods from pages on the monitored website. In accordance with one or more embodiments, each RetailerLookup component 114 configured to parse a web page or other electronic document is programmed to recognize the layout of the monitored page(s)/document and a location of a piece of information that is of interest to the PPNS 100 within a page/document. In some cases, an item's pricing is not made available until the user adds the item to the shopping cart. In such a case, the RetailerLookup component 114 can be configured to manipulate content such that it can retrieve the price of such an item from a web page that includes a shopping cart, so as to determine the price of such an item. In addition, the RetailerLookup component 114 is configured to recognize exceptional conditions, e.g., when the item is no longer being sold, when it is currently sold out, or when it is being provided by another seller that doesn't offer the same policies as the monitored seller.

In accordance with one or more embodiments of the present disclosure, each instance of a RetailerLookup component 114 implements a shared query and response interface which allows it to be plugged into the item lookup catalog 104. In addition, the modular architecture allows a new seller to be added to the PPNS 100. For example, a programmer can implement a new RetailerLookup component 114 and register it programmatically with the item lookup catalog 104 for a new seller, or retailer, or website.

In accordance with one or more embodiments, the item lookup catalog 104, and/or a Retailer Lookup 114, can use one or more web services and/or APIs to fetch information for and about the purchased item for use in identifying the initial information about the item, e.g., during registration of the item with the PPNS 100, and/or to fetch updates to the initial information. In accordance with one or more embodiments, the item lookup catalog 104, of the Retailer Lookup 114, can use a combination of parsing a web page 116 and requesting information via a web service/API 118.

The item catalog 104 can be queried or “called” by the notification engine 106 and the web-facing front end 108. The catalog 104 is queried with an item URL and initiates the lookup process. In response, item catalog 104 makes a determination whether or not a response is stored in a lookup memory cache, which stores recently-generated responses (e.g., within the last five minutes). The item lookup catalog 104 queries the lookup memory cache for immediate access to a recently-generated response, if one exists in the cache. If a recent response is found in the cache, it is returned to the requester, e.g., notification engine 106 or web-facing front end 108. If the item lookup catalog 104 does not find an item in the cache, e.g., the item does not exist in the cache, the request is delegated to the RetailerLookup 114 that is registered to handle requests for the specific retailer for which the information is requested, which can be identified using the URL provided in the request. The RetailerLookup 114 processes the request and returns a result to the item lookup catalog 104. The retrieved information is then passed to the requester, e.g., the web-facing front end 108 or the notification engine 106.

In accordance with one or more embodiments, when queried, the item lookup catalog 104 can return a number of responses. By way of some non-limiting examples, the item lookup catalog 104 can provide “unsupported retailer”, “product not available”, “product sold through another vendor”, “lookup complete”, “lookup incomplete”, and/or “informational” responses.

The “unsupported retailer” response is provided by the item lookup catalog 104 in a case that there is no RetailerLookup 114 component registered to handle requests for the seller or website specified in the query/request received from the notification engine 106 or the web-facing front end 108. The “product not available” response can be returned in a case that the item for which information is being requested has moved, the user has entered an otherwise invalid product link, or the item is otherwise not able to be parsed. The “product sold through another vendor” response can be returned in a case that a seller that allows other sellers, e.g., sub-sellers, to sell items through the other sellers' website(s), and the sub-seller of the item does not honor the seller's price protection policy. The “lookup complete” can be returned with a successful lookup, together with information that includes, for example, the item name, URL, protection period, price, and/or other relevant information. The “lookup incomplete” response can be returned by the item lookup catalog 104 in case that the item is able to be parsed as expected, but may not contain a complete set of item information. The “informational” response can be returned in a case that the response doesn't fall into any of the above categories. In such a case, the item lookup catalog 104 can return an informational response with extended error information.

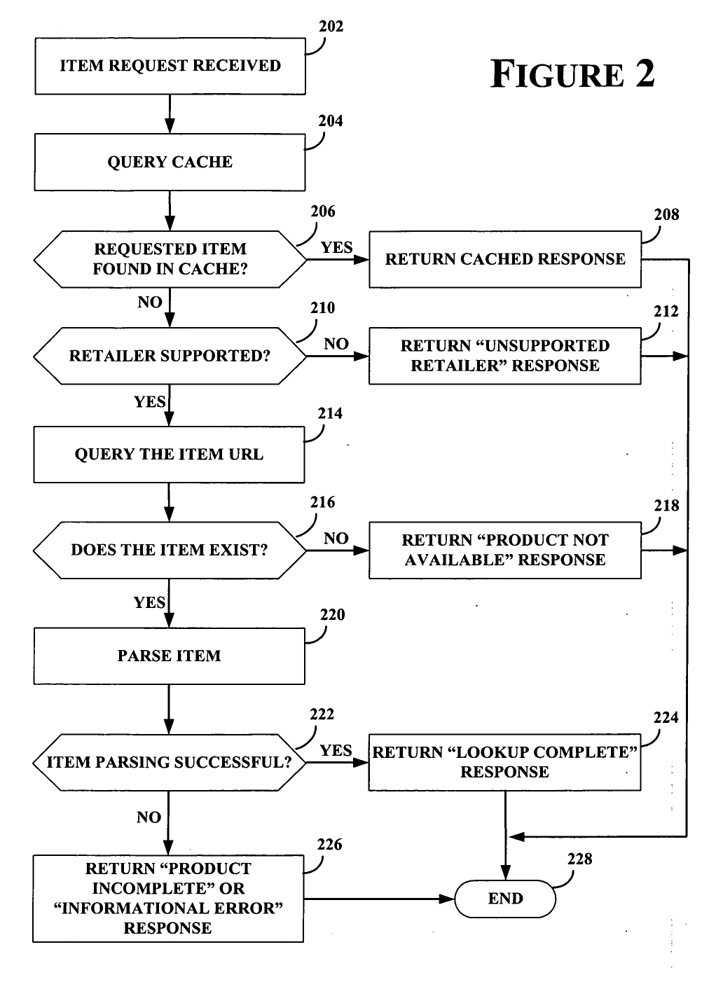

FIG. 2 provides an item lookup catalog process flow for use in accordance with one or more embodiments of the present disclosure. At step 202, a request for information about an item is received by the item lookup catalog 104. At step 204, the recent response cache is examined to determine whether or not a recent response was formed for the item identified in the request. If so, processing continues at step 208 to return the cached response to the requester, and processing ends for the current request at step 228. If not, processing continues at step 210 to determine whether or not there is a RetailerLookup 114 component for the retailer associated with the item identified in the request. If not, processing continues at step 212 to return an “unsupported retailer” response, and processing ends for the current request at step 228.

If there is a RetailerLookup 114 component for the retailer of the item, processing continues at step 214 to retrieve item information using the item URL. In accordance with one or more embodiments, the RetailerLookup 114 component is configured to retrieve information about the item from the website identified by the URL. At step 216, a determination is made whether or not the item is found at the website queried by the RetailerLookup 114 component. If not, processing continues at step 218 to return a “product not available” response to the requester, and processing ends for the current request at step 228.

If the RetailerLookup 114 component determines that the item exists, processing continues at step 220 to parse the information retrieved from the web site identified by the URL to retrieve the information about the requested item. At step 222, a determination is made whether or not the item parsing was successful. If parsing was successful in retrieving the requested information, processing continues at step 224 to return the “lookup complete” response, and the requested information about the item identified in the received request. Processing ends for the completed lookup at step 228. If it was determined at step 222 that the parsing was not successfully completed, processing continues at step 226 to return a “product incomplete” or “informational error” response, as appropriate.

In accordance with one or more embodiments of the disclosure, the notification engine 106 is configured to perform background processing of the items under protection in the PPNS 100 during the lifetime of each item's protection period. The notification engine 106 is configured to query the database 112 to find all distinct items that are flagged as being under price protection. For purposes of load balancing, or distributing the load, the notification engine 106 is further configured to distribute the load across all of the items over a twelve hour period of time on a per-seller basis. In accordance with one or more embodiments, each item that is being tracked by the PPNS 100 is checked at least one during a twelve hour period. However and in a case that seller website queries have a minimum query interval, the aggregate query time may exceed twelve hours for a given seller in an overloaded scenario. In accordance with one or more embodiments, the notification engine 106 is configured to distribute the load evenly and avoid querying the seller, or retailer, so often that it looks like a denial of service (DOS) attack on the seller's server.

Once the notification engine 106 determines an optimal sleep, or interval, time between item lookups for each seller based on considerations such as those described above, the notification engine 106 picks an item at random during each interval. The notification engine queries the item lookup catalog 104 for the current item's information and updates the database and the user via electronic notification, where appropriate.

When the notification engine 106 begins processing an item, it has a number of possible outcomes. The following are some non-limiting examples of outcomes of processing by the notification engine 106. If the item's protection period has lapsed, the notification engine 106 completes the lookup request by marking the item as “off protection” in the Protection table and sending an “off protection” electronic notification to the user. In accordance with one or more embodiments, the “off protection” notification can include a summary of information collected over the protection period. If the item lookup catalog 104 component of the PPNS 100 returns a “lookup complete” response and the current price is less than the lowest price marked in the Protection table, the Protection table is updated, statistics are added to the ItemHistory table, and the user is notified of the price drop via an electronic notification. If the item lookup catalog 104 returns a “lookup complete” response and the current price is greater than or equal to the lowest price marked in the Protection table, statistics are added to the ItemHistory table. There is no need to notify the user, since there is no price drop. If the item lookup catalog 104 returns a “product not available” response, the item is marked as being “off protection” in the Protection table, statistics are added to the ItemHistory table, and the user is notified via electronic notification that the item has been taken off price protection. If the item lookup catalog 104 returns any other type of response, the ItemHistory table is updated with a NULL, price assuming a non-permanent error.

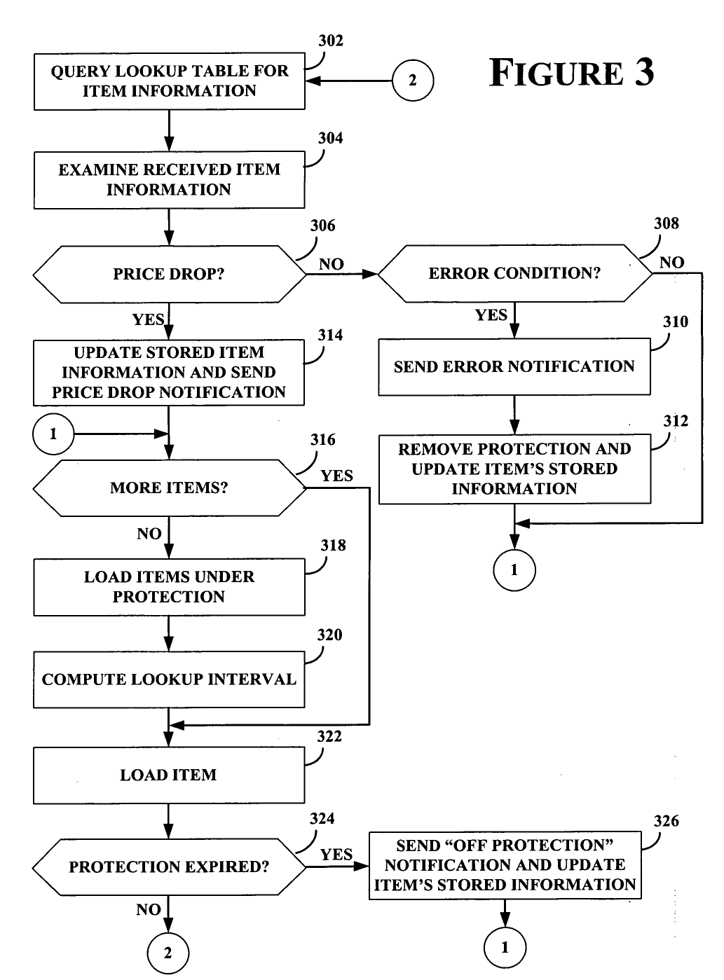

FIG. 3 provides a notification engine process flow for use in accordance with one or more embodiments of the present disclosure. At step 302, the notification engine 106 selects an item at random and queries the item lookup catalog 104 for the current item's information. At step 304, the information received from the item lookup catalog 104 in response is examined, and a determination is made at step 306 whether the price of the item has dropped from a known price of the item, e.g., the most current price, which can be the purchase price, for the item stored in database 112. If not, processing continues at step 308 to examine the response received from the item lookup catalog 104 to determine whether or not an error condition exists. If an error condition is detected, processing continues at step 310 to send an error notification to the user, price protection associated with the given item is removed, and the item's stored information is updated to reflect the removal of protection for the item, at step 312. After processing the error condition, processing continues at step 316 to process any remaining items, e.g., items for the same or a different seller. If no error condition is detected at step 308, processing continues at step 316 to process any remaining items.

If it is determined at step 306 using the information received from the item lookup catalog 104 and the information stored in database 112 for the item that there is a drop in price, processing continues at step 314 to update the item's stored information, e.g., to replace/add the latest pricing information to the item's information stored in database 112. In addition and at step 314, the PPNS 100 notifies the user that there is a drop in the price of the item that is protected by a price protection policy, e.g., the seller's price protection policy. In accordance with one or more embodiments, the notification can identify a process that is to be used by the user to request a refund in accordance with the price protection policy by which the item is covered. Processing continues at step 316 to process any items that remain to be processed.

At step 316, a determination is made whether or not there are any more items that remain to be processed. For example, the determination can be made using the load balancing/distributing considerations discussed above. If there are no items that remain to be processed in a current group of items, processing continues at step 318 to identify a next, or other, group of items that are to be processed. The items to be included is such a group can include items that remain under price protection. At step 320, the notification engine 106 determines a lookup interval for each of the items identified at step 318. At step 322, an item from the group is selected in accordance with the determined lookup interval, and the stored information from the database 112 is retrieved. At step 324 a determination is made whether the protection period for the item is expired. The determination can be made based on price protection policy time period information stored in database 112, for example. If so, an “off protection” message is sent to the user, and the item's stored information is updated to reflect that the item is no longer under protection. Processing continues at step 316 to process any remaining items in the current group of items.

If it is determined, at step 324, that the item remains under protection, processing continues at step 302 to retrieve the latest information for the item from the seller's website using the URL associated with the item, e.g., the URL retrieved from the database 112 for the item. Processing continues at step 304 to examine the information received from the seller's website for the item in a manner similar to that discussed above with reference to steps 304, 306, 308, 310, etc.

The web-facing front end 108 provides the primary user data entry point for PPNS 100. In addition to a data entry point, it provides both a user experience and a validation layer.

The web-facing front end 108 provides a mechanism by which the user can enter information to initiate price protection and notification for a given item. The user can identify the URL, that is to be used by the PPNS 100 to monitor the item's pricing and to collect a pricing history for the item. When the user enters an item URL, the navigation engine 106 of the PPNS 100 queries the item lookup catalog 104 and returns information for review and/or confirmation by the user.

If a “Lookup Complete”\ response is returned, the user is asked to validate the information provided by the PPNS 100. In addition, the user is allowed to modify the information, e.g., in a case that the user identifies an error, upon review by the user of the information provided by the user and/or the information retrieved and displayed by the PPNS 100. The user is given the opportunity to modify the item information before placing the item under price protection. Once the user submits the item to the PPNS 100, it is validated again by the PPNS 100. If the item is successfully validated, the item is entered into the PPNS 100. When the notification engine 106 begins its next cycle, e.g., the processing discussed with reference to FIG. 3, the new item is loaded and processed.

In accordance with one or more embodiments, the web-facing front end 108 allows users to view aggregated statistics about the PPNS 100. By way of some non-limiting examples, users can use the web-facing front end 108 to view how many items are actively being protected, the total amount of money saved by users, and a breakdown of average price drop amounts.

In addition and in accordance with one or more embodiments, the web-facing front end 108 allows a user to update and manage their account settings as well as view a detailed personal price protection history.

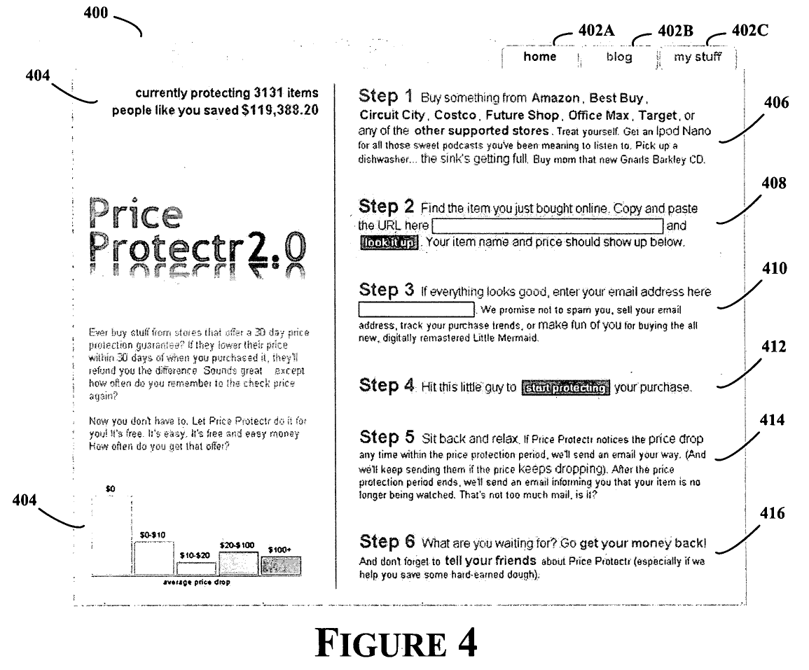

FIG. 4 provides an example of a user interface (UI) provided by the web-facing front end 108 component in accordance with one or more embodiments of the present disclosure. In accordance with one or more such embodiments, the user interface provided by the web-facing front end 108 displays a screen of information such as that shown in FIG. 4. User interface component 400 can be a window that is displayed by a browser application operating on a user computer, for example. The PPNS 100 is configured to define user interface component 400 for display at the user computer. In the example shown in FIG. 4, UI 400 includes one or more tabs 402 for use by the user to navigate from one window to another in the UI. By selecting tab 402A, for example, the user can register an item with the PPNS 100. Tab 402B results in UI 400 displaying a blog, that allows the user to communicate with other users and/or the PPNS 100, e.g., customer support and/or system administration. Tab 402C causes the web-facing front end 108 to display information specific to a given user in the UI 400.

In addition and in accordance with one or more embodiments, UI 400 includes aggregate information 404, which provides information about the PPNS 100. By way of some non-limiting examples, the aggregate information can identify the number of items that are currently under protection by the PPNS 100, the amount of money saved by users of the PPNS 100, and a breakdown of price drops identified by the PPNS 100, e.g., a number of prices drops by ranges of average price drops.

In the example shown in FIG. 4, UI 400 identifies a series of steps for the user as a part of the user interface experience presented to the user by the web-facing front end 108. In step 1, reference 406, the user is given some initial information to get the user started, e.g., the user is prompted to make a purchase by visiting a seller's website to purchase a good or a service. Step 2, reference 408, prompts the user to enter the URL for the item or service that the user purchased. As indicated, once the user enters the URL, the web-facing front end 108 uses the URL to retrieve information for the item and display the name and purchase price for the item in UI 400. The user is requested at step 3, reference 410, to enter an electronic mail (email) address to be used by the PPNS 108 to notify the user of the price protection status of the item. At step 4, reference 412, the user is prompted to initiate price protection for the item identified in step 2, reference 408, and to submit the email address information by clicking the “start purchasing” element in step 4, reference 412. As indicated by steps 5 and 6, references 414 and 416 (respectively), the PPNS 100 notifies the user of a detected price drop for the item identified in step 2, reference 408, so that the seller can be contacted to request the refund, e.g., in the amount of the price drop.

In accordance with one or more embodiments of the present disclosure, a user can access the PPNS 100 via a mobile or handheld device. By way of a non-limiting example, the user can use the mobile or handheld device to register with the PPNS 100 and/or to receive an electronic notification. For example, it is possible for a user to use a handheld computing device, e.g., a smart phone, to access the web-facing front end 108 to register with the PPNS 100. By way of a further non-limiting example, a handheld device can be configured to receive one or more of email, SMS, and instant messages sent by the PPNS 100. The mobile device can be a cellular phone, smart phone, navigation (e.g., global positioning satellite), gaming device, media playback device, etc. One or more such handheld or mobile devices can be used as an alternative, or in addition, to a personal computer, e.g., desktop or laptop computer.

Embodiment of General Purpose Computer Environment:

The following a description of a general-purpose computer environment that may be utilized to implement various portions of the invention. Such general-purpose computer can comprise a personal computer, a server, a handheld computing device (e.g., smart phone and/or GPS, gaming, player etc. devices), appliance, etc.

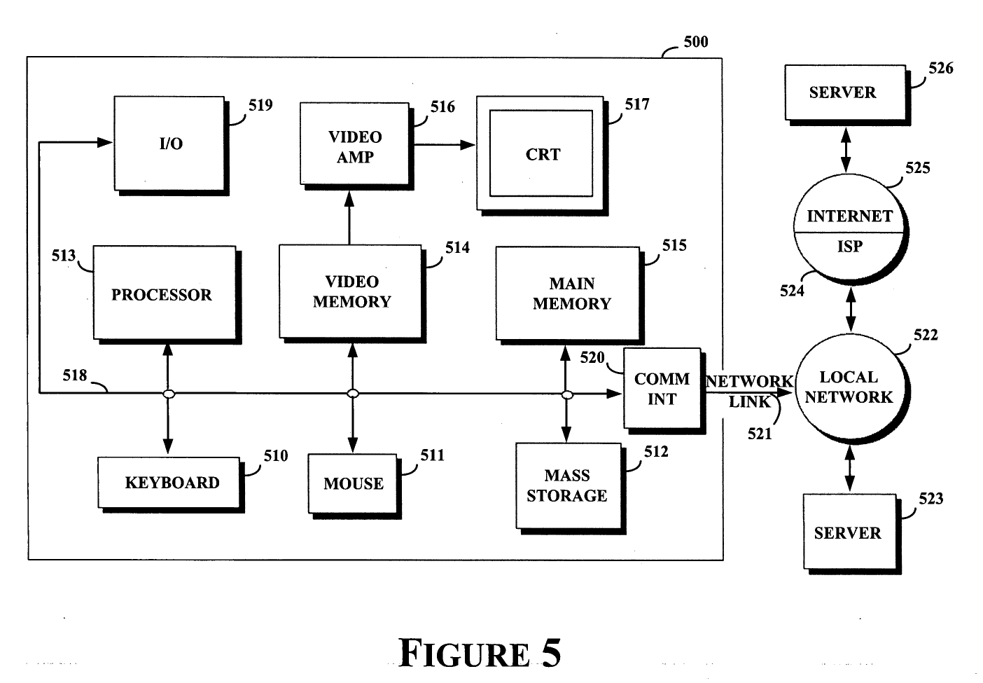

One or more embodiments of the disclosure can be implemented as computer software in the form of computer readable program code executed on one or more general-purpose computers such as the computer 500 illustrated in FIG. 5. Computer 500 can be a server, such as a server that alone or in combination with other servers implements the PPNS 100, for example. By way of a further non-limiting example, computer 500 can be a user computer, such as a computer that is used by a user to access the web-facing front end 108 of the PPNS 100, a computer with which the user accesses an electronic notification provided by the PPNS 100, and/or a computer with which the user accesses a seller's web site to purchase an item.

With reference to FIG. 5, a keyboard 510 and mouse 511 are coupled to a bi-directional system bus 518 (e.g., PCI, ISA or other similar architecture). The keyboard and mouse are for introducing user input to the computer system and communicating that user input to central processing unit (CPU) 513. Other suitable input devices may be used in addition to, or in place of, the mouse 511 and keyboard 510. I/O (input/output) unit 519 coupled to bi-directional system bus 518 represents possible output devices such as a printer or an A/V (audio/video) device.

Computer 500 includes video memory 514, main memory 515, mass storage 512, and communication interface 520. All these devices are coupled to a bi-directional system bus 518 along with keyboard 510, mouse 511 and CPU 513. The mass storage 512 may include fixed and/or removable media, such as magnetic, optical or magnetic optical storage systems or any other available mass storage technology. The system bus 518 provides a means for addressing video memory 514 or main memory 515. The system bus 518 also provides a mechanism for the CPU to transfer data between and among the components, such as main memory 515, video memory 514 and mass storage 512.

In one embodiment of the invention, the CPU 513 is a microprocessor manufactured by Motorola, such as the 680X0 processor, an Intel processor, and the like. However, any other suitable processor or computer now known or later developed may be utilized. Video memory 514 is a dual ported video random access memory. One port of the video memory 514 is coupled to video accelerator 516. The video accelerator device 516 is used to drive a CRT (cathode ray tube), and LCD (Liquid Crystal Display), or TFT (Thin-Film Transistor) monitor 517. The video accelerator 516 is well known in the art and may be implemented by any suitable apparatus. This circuitry converts pixel data stored in video memory 514 to a signal suitable for use by monitor 517. The monitor 517 is a type of monitor suitable for displaying graphic images.

The computer 500 may also include a communication interface 520 coupled to the system bus 518. The communication interface 520 provides a two-way data communication coupling via a network link 521 to a network 522. For example, if the communication interface 520 is a modem, the communication interface 520 provides a data communication connection to a corresponding type of telephone line, which comprises part of a network link 521. If the communication interface 520 is a Network Interface Card (NIC), communication interface 520 provides a data communication connection via a network link 521 to a compatible network. Physical network links can include Ethernet, wireless, fiber optic, and cable television type links. In any such implementation, communication interface 520 sends and receives electrical, electromagnetic or optical signals which carry digital data streams representing various types of information.

The network link 521 typically provides data communication through one or more networks to other data devices. For example, network link 521 may provide a connection through local network 522 to a host computer 523 or to data equipment operated by an Internet Service Provider (ISP) 524. ISP 524 in turn provides data communication services through the worldwide packet data communication network now commonly referred to as the Internet 525. Local network 522 and Internet 525 both use electrical, electromagnetic or optical signals that carry digital data streams to files. The signals through the various networks and the signals on network link 521 and through communication interface 520, which carry the digital data to and from computer 500, are exemplary forms of carrier waves for transporting the digital information.

The computer 500 can send messages and receive data, including program code, through the network(s), network link 521, and communication interface 520. In the Internet example, server 526 might transmit a requested code for an application program through Internet 525, ISP 524, local network 522 and communication interface 520.

In one embodiment of the invention a thin-client device is configured to interface with the computer system described above via a computer network. In other instances (e.g., when a smart mobile device is utilized) some or all of the components discussed above are incorporated into the device. It will be evident to one of ordinary skill in the art that the computer systems described above are for purposes of example only. An embodiment of the invention may be implemented in any type of computer system or programming or processing environment.

For the purposes of this disclosure a computer readable medium stores computer data, which data can include computer program code executable by a computer, in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Thus, a price protection system and method has been described. Particular embodiments described herein are illustrative only and should not limit the present invention thereby. The claims and their full scope of equivalents define the invention.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A computer-implemented method for providing an electronic notification of eligibility for a refund in accordance with a price protection policy, the method comprising:
storing information associated with a purchase transaction involving a buyer and an item purchased, said information including buyer information, identification of the purchased item, date of purchase and a transaction price for the purchased item;
monitoring information retrieved from at least one web page to identify a change in status associated with the purchased item, said retrieved information identifying a current purchase price for the purchased item;
determining whether the buyer is eligible for a refund using the stored information and the retrieved information; and
notifying the buyer if it is determined that the buyer is eligible for a refund due to the buyer under a price protection policy.

2. The method of claim 1, said determining whether the buyer is eligible for a refund further comprising:
determining, using the stored and retrieved information, whether or not the purchased item has a current purchase price that is lower than the transaction price within a given time period after the purchase transaction.

3. The method of claim 1, said step of storing information associated with a purchase transaction further comprising:
parsing at least one web page of a website to collect the information associated with the purchase transaction.

4. The method of claim 1, said step of storing information associated with a purchase transaction further comprising:
receiving at least a portion of the information associated with the purchase transaction from an electronic data feed service.

5. The method of claim 1, said step of storing information associated with a purchase transaction further comprising:
requesting at least a portion of the information associated with the purchase transaction via a web service or application programming interface.

6. The method of claim 1, further comprising:
comparing the transaction price for the purchased item with the current price for the item to determine whether or not the current price is less than the transaction price,
wherein said determining whether the buyer is eligible for a refund using the stored information and the retrieved information determines that the buyer is eligible for a refund if the current price is more than the transaction price.

7. The method of claim 1, said notifying the buyer if it is determined that the buyer is eligible for a refund due to the buyer under a price protection policy further comprises:
updating the stored information to include the information identifying that the user is eligible for a refund.

8. A computer-readable medium storing computer-readable program code for providing an electronic notification of eligibility for a refund in accordance with a price protection policy, the program code comprising:
code to store information associated with a purchase transaction involving a buyer and an item purchased, said information including buyer information, identification of the purchased item, date of purchase and a transaction price for the purchased item;
code to monitor information retrieved from at least one web page to identify a change in status associated with the purchased item, said retrieved information identifying a current purchase price for the purchased item;
code to determine whether the buyer is eligible for a refund using the stored information and the retrieved information; and
code to notify the buyer if it is determined that the buyer is eligible for a refund due to the buyer under a price protection policy.

9. The medium of claim 8, said code to determine whether the buyer is eligible for a refund further comprising:
code to determine, using the stored and retrieved information, whether or not the purchased item has a current purchase price that is lower than the transaction price within a given time period after the purchase transaction.

10. The medium of claim 8, said code to store information associated with a purchase transaction further comprising:
code to parse at least one web page of a website to collect the information associated with the purchase transaction.

11. The medium of claim 8, said code to store information associated with a purchase transaction further comprising:
code to receive at least a portion of the information associated with the purchase transaction from an electronic data feed service.

12. The medium of claim 8, said code to store information associated with a purchase transaction further comprising:
code to request at least a portion of the information associated with the purchase transaction via a web service or application programming interface.

13. The medium of claim 8, further comprising:
code to compare the transaction price for the purchased item with the current price for the purchased item to determine whether or not the current price is less than the transaction price,
wherein said code to determine whether the buyer is eligible for a refund using the stored information and the retrieved information determines that the buyer is eligible for a refund if the current price is more than the transaction price.

14. The medium of claim 8, said code to notify the buyer if it is determined that the buyer is eligible for a refund due to the buyer under a price protection policy further comprises:
code to update the stored information to include the information identifying that the user is eligible for a refund.

15. An apparatus for providing an electronic notification of eligibility for a refund in accordance with a price protection policy, the apparatus comprising:
one or more processors configured to:
store information associated with a purchase transaction involving a buyer and an item purchased, said information including buyer information, identification of the purchased item, date of purchase and a transaction price for the item;
monitor information retrieved from at least one web page to identify a change in status associated with the purchased item, said retrieved information identifying a current purchase price for the purchased item;
determine whether the buyer is eligible for a refund using the stored information and the retrieved information; and
notify the buyer if it is determined that the buyer is eligible for a refund due to the buyer under a price protection policy.

16. The apparatus of claim 15, said one or more processors configured to determine whether the buyer is eligible for a refund being further configured to:
determine, using the stored and retrieved information, whether or not the purchased item has a current purchase price that is lower than the transaction price within a given time period after the purchase transaction.

17. The apparatus of claim 15, said one or more processors configured to store information associated with a purchase transaction being further configured to:
parse at least one web page of a website to collect the information associated with the purchase transaction.

18. The apparatus of claim 15, said one or more processors configured to store information associated with a purchase transaction further configured to:
receive at least a portion of the information associated with the purchase transaction from an electronic data feed service.

19. The apparatus of claim 15, said one or more processors configured to store information associated with a purchase transaction further configured to:
request at least a portion of the information associated with the purchase transaction via a web service or application programming interface.

20. The apparatus of claim 15, said one or more processors being further configured to:
compare the transaction price for the purchased item with the current price for the purchased item to determine whether or not the current price is less than the transaction price,
wherein said one or more processors configured to determine whether the buyer is eligible for a refund using the stored information and the retrieved information determine that the buyer is eligible for a refund if the current price is more than the transaction price.

21. The apparatus of claim 15, said one or more processors configured to notify the buyer if it is determined that the buyer is eligible for a refund due to the buyer under a price protection policy being further configured to:
update the stored information to include the information identifying that the user is eligible for a refund.

22. A system for providing an electronic notification of eligibility for a refund in accordance with a price protection policy, said system comprising:
a data store configured to store information associated with a purchase transaction involving a buyer and an item purchased, said information including buyer information, identification of the purchased item, date of purchase and a transaction price for the purchased item;
a notification engine configured to:
monitor information retrieved from at least one web page to identify a change in status associated with the purchased item, said retrieved information identifying a current purchase price for the purchased item;
determine whether the buyer is eligible for a refund using the stored information and the retrieved information; and
notify the buyer if it is determined that the buyer is eligible for a refund due to the buyer under a price protection policy.

23. The system of claim 22 further comprising:
an item lookup configured to parse at least one web page of a website to collect the information associated with the purchase transaction.

24. The system of claim 22 further comprising:
an item lookup configured to receive at least a portion of the information associated with the purchase transaction from an electronic data feed service.

25. The system of claim 22 further comprising:
an item lookup configured to request at least a portion of the information associated with the purchase transaction via a web service or an application programming interface.

26. The system of claim 22 further comprising:
a front end configured to:
display a user interface to receive and confirm registration information about the item purchased.

27. The system of claim 26, said front end is further configured to:
display an administrative interface to allow the buyer as a user of the system to view user-specific information.
